(19) United States
(12) Patent Application Publication
(10) Pub. No.: US 2017/0235422 A1
(43) Pub. Date: Aug. 17, 2017

(54) TOUCH SCREEN, DISPLAY APPARATUS CONTAINING THE SAME, METHOD FOR CONTROLLING THE SAME, AND RELATED CONTROL APPARATUS

(71) Applicant: BOE TECHNOLOGY GROUP CO., LTD, Beijing (CN)

(72) Inventor: JIAYANG ZHAO, Beijing (CN)

(21) Appl. No.: 15/109,938

(22) PCT Filed: Dec. 10, 2015
(86) PCT No.: PCT/CN2015/096947

§ 371 Date: Jul. 6, 2016

(30) Foreign Application Priority Data
Aug. 13, 2015 (CN) 201510498300.1

(51) Int. Cl. G06F 3/041; G06F 3/044

(52) U.S. Cl. CPC G06F 3/0418; G06F 3/044

(57) ABSTRACT

The present disclosure provides a touch screen. The touch screen includes a plurality of touch electrodes arranged in an array; and a plurality of electrode lines, each electrode line being connected to at least one touch electrode. The plurality of touch electrodes includes a first touch electrode set and a second touch electrode set; each touch electrode in the first touch electrode set is connected to a distinct electrode line, each electrode line being connected to one corresponding touch electrode; and at least two touch electrodes in the second touch electrode set are connected to a common electrode line, wherein each of the at least two touch electrodes in the second touch electrode set is neighbored with at least one touch electrode in the first touch electrode set.

### CROSS-REFERENCES TO RELATED APPLICATIONS

This PCT patent application claims priority of Chinese Patent Application No. 201510498300.1, filed on Aug. 13, 2015, the entire content of which is incorporated by reference herein.

### FIELD OF THE INVENTION

The present invention generally relates to the display technologies and, more particularly, relates to a touch screen, a display apparatus containing the same, a method for controlling the same, and a related control apparatus.

### BACKGROUND

As the development of touch-sensing technologies, touch display devices have been widely used in industry and daily life. A touch display device often includes a self-capacitance touch screen and a processing circuitry. The self-capacitance touch screen often includes a plurality of touch electrodes and a plurality of electrode lines are arranged in arrays, and one touch electrode corresponds to or is connected to one electrode line. One electrode line is connected to the corresponding touch electrode and the processing circuitry.

The processing circuitry often senses the signals generated from touch motions on the self-capacitance touch screen and controls the self-capacitance touch screen to display images. For example, when the user touches any one of the touch electrodes on the self-capacitance touch screen with a finger, the touch electrode generates signals. The processing circuitry receives the signal generated by the touch electrode through the electrode line connected to the touch electrode and determines the value of the signal. The processing circuitry also compares the signal generated by the touch electrode with a touch-sensing threshold value. When the signal generated by the touch electrode is greater than the touch-sensing threshold value, the processing circuitry determines the touch electrode to be a target touch electrode and obtains the location information of the target touch electrode. The processing circuitry also controls the self-capacitance touch screen to display corresponding images based on the location information of the target touch electrode.

In existing touch-sensing technologies, it is often required that each touch electrode of the self-capacitance touch screen is connected to an electrode line. That is, a plurality of electrode lines is arranged on the self-capacitance touch screen. As a result, the structure of the self-capacitance touch screen is considerably complicated, and the fabrication or production cost of the self-capacitance touch screen is high.

### BRIEF SUMMARY OF THE DISCLOSURE

The present disclosure provides a touch-sensing display panel, a display apparatus containing the same, a method for controlling the same, and a related control apparatus. By using the touch-sensing display and the related control apparatus, the number of electrode lines used in the self-capacitance touch screen can be reduced, and the structure of the self-capacitance touch screen can have reduced complexity. The fabrication cost of the self-capacitance touch screen can be lower.

One aspect of the present disclosure includes a touch screen. The touch screen includes a plurality of touch electrodes arranged in an array; and a plurality of electrode lines, each electrode line being connected to at least one touch electrode. The plurality of touch electrodes includes a first touch electrode set and a second touch electrode set; each touch electrode in the first touch electrode set is connected to a distinct electrode line, each electrode line being connected to a distinct touch electrode; and at least two touch electrodes in the second touch electrode set are connected to a common electrode line, wherein each of the at least two touch electrodes in the second touch electrode set is neighbored with at least one touch electrode in the first touch electrode set.

Optionally, each of the first touch electrode set and the second touch electrode set includes a plurality of touch electrode groups arranged along a first direction, each touch electrode group including at least two touch electrodes; and the first touch electrode set and the second touch electrode set are arranged in an alternating manner along a second direction, the second direction being perpendicular to the first direction.

Optionally, a distance between any two of the at least two touch electrodes sharing the one electrode line in the second touch electrode set is greater than a distance.

Optionally, a number of touch electrodes between any two of the at least two touch electrodes sharing the one electrode line in the second touch electrode set is greater than or equal to (0.5n−1), (0.5n−1) being a rounded integer according to n, and n being a number of touch electrodes in a corresponding touch electrode group.

Optionally, the processing circuitry is configured to select at least one test electrode and determining a target touch electrode among the at least one test electrodes, wherein the at least one test electrode has effective contact with a finger or a conductive stylus.

Another aspect of the present disclosure provides a touch display apparatus. The touch display apparatus includes one or more of the disclosed touch screens.

Another aspect of the present disclosure provides a control apparatus for controlling the disclosed touch screen. The control apparatus includes a first determining circuitry, configured to determine a test electrode contacted by a finger or a conductive stylus; a first obtaining circuitry, configured to obtain a number of m reference signals generated by the touch electrodes neighbored with the test electrode, wherein m is an integer greater than or equal to 1; a second determining circuitry, configured to determine a value of each one of the m reference signals; a comparing circuitry, configured to compare the value of each one of the m reference signals to a ghost point threshold value to determine if the value of each one of the m reference signals is greater than the ghost point threshold value; and a third determining circuitry, configured to determine a target touch electrode when the value of each one of the m reference signals is greater than the ghost point threshold value.

Optionally, the control apparatus further includes a fourth determining circuitry, configured to determine when a value of at least one of the m reference signals is less than or equal to the ghost point threshold value, the test electrode is not the target touch electrode.

Optionally, the first determining circuitry is configured to obtain a signal generated by a first electrode through an electrode line connected with the first electrode, where the first electrode is any touch electrode in the plurality of touch electrodes; determine a value of the signal generated by the first electrode; compare if the value of the signal generated by the first electrode is greater than the touch-sensing threshold value, where the touch-sensing threshold value is greater than the ghost point threshold value; and determine the first electrode to be a test electrode if the value of the signal generated by the first electrode is greater than the touch-sensing threshold value.

Optionally, the control apparatus further includes a second obtaining circuitry, configured to obtain location information of the target touch electrode; and a controlling circuitry, configured to control the touch screen to display images based on the location information of the target touch electrode.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a structure of an existing touch screen;

FIG. 2 illustrates a structure of an exemplary touch screen according to various disclosed embodiments of the present disclosure;

FIG. 3 illustrates a structure of another exemplary touch screen according to various disclosed embodiments of the present disclosure;

FIG. 4 illustrates a structure of another exemplary touch screen according to various disclosed embodiments of the present disclosure;

FIG. 5 illustrates a process flow of an exemplary method for controlling a touch screen according to various disclosed embodiments of the present disclosure;

FIG. 6 (a) illustrates a process flow of another exemplary method for controlling a touch screen according to various disclosed embodiments of the present disclosure; FIG. 6 (b) illustrates a correspondence relationship between touch electrodes and electrode lines; and FIG. 6 (c) illustrates an exemplary signal distribution according to various disclosed embodiments of the present disclosure;

FIG. 7 (a) illustrates an exemplary control apparatus for a touch screen according to various disclosed embodiments of the present disclosure; FIG. 7 (b) illustrates another exemplary control apparatus for the touch screen according to various disclosed embodiments of the present disclosure; and FIG. 7 (c) illustrates another exemplary control apparatus for a touch screen according to various disclosed embodiments of the present disclosure; and

FIG. 8 illustrates an exemplary processing circuitry used in some embodiments of the present disclosure.

### DETAILED DESCRIPTION

For those skilled in the art to better understand the technical solution of the invention, reference will now be made in detail to exemplary embodiments of the invention, which are illustrated in the accompanying drawings. Wherever possible, the same reference numbers will be used throughout the drawings to refer to the same or like parts.

One aspect of the present disclosure provides a touch screen.

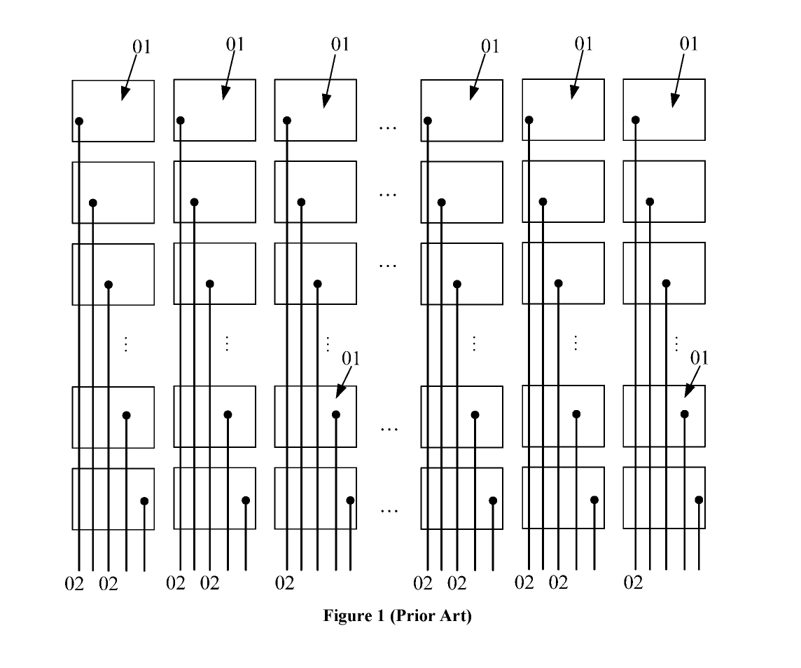

FIG. 1 illustrates the structure of an existing touch screen 000. The touch screen 000 includes a plurality of touch electrodes 01 and a plurality of electrode lines 02 arranged in arrays. Each one of the plurality of touch electrodes corresponds to one of the plurality of electrode lines 02. Each electrode line 02 is connected to the corresponding touch electrode 01 and a processing circuitry (not shown).

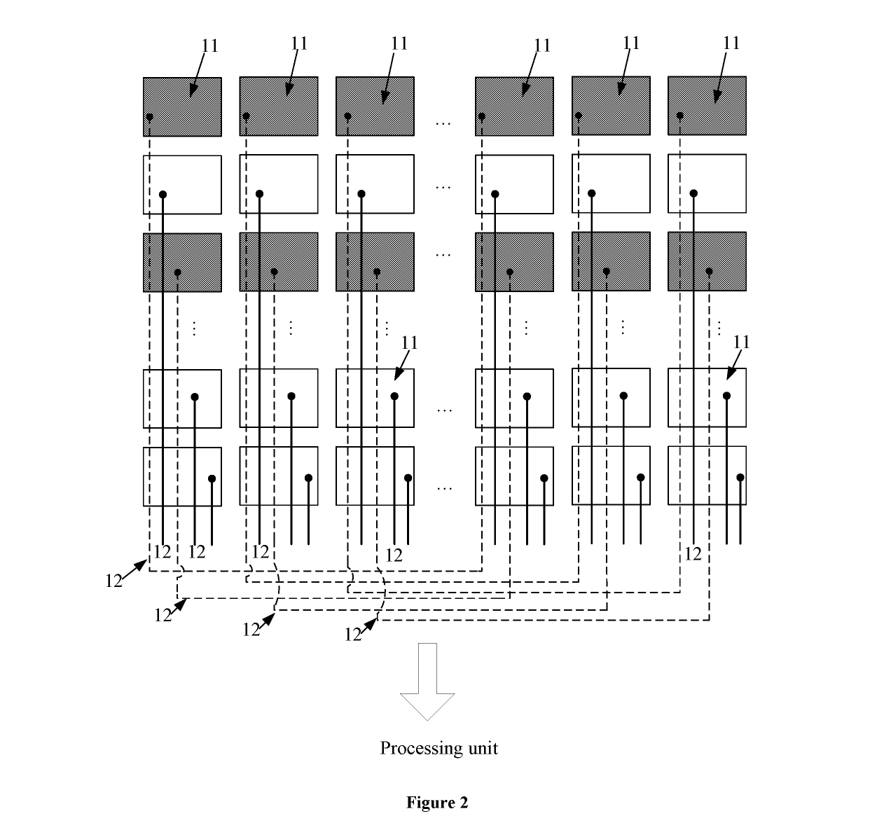

As shown in FIG. 2, embodiments of the present disclosure provide a touch screen 001. The touch screen 001 may include a plurality of touch electrodes 11 arranged in an array and a plurality of electrode lines 12 arranged in an array.

The plurality of touch electrodes 11 may include a first touch electrode set and a second touch electrode set. For illustrative purposes, the touch electrodes 11 in the second touch electrode set are shaded and the touch electrodes 11 in the first electrode set are illustrated in clear. Each touch electrode 11 in the first touch electrode set may correspond to one electrode line 12. At least two touch electrodes 11 in the second touch electrode set may share one common electrode line. Each touch electrode 11 in the second touch electrode set may be neighbored with at least one touch electrode 11 in the first touch electrode set.

For illustrative purposes, in the disclosure, the shared common electrode lines are illustrated by dashed lines, connecting two or more touch electrodes; and an electrode line connected to only one touch electrode is illustrated by solid lines. The electrode lines, shared or not shared by more than one common touch electrodes, may be used to connect the corresponding touch electrode to the processing circuitry such that the processing circuitry may respond to the touch motions and control the touch screen to perform different functions.

That is, in the touch screen provided by the present disclosure, each touch electrode in the first touch electrode set may correspond to one electrode line, and at least two touch electrodes in the second touch electrode set may share one common electrode line, i.e., use a same common electrode line. Also, each touch electrode in the second touch electrode set may be neighbored with at least one touch electrode in the first touch electrode set. It may not be required to connect each touch electrode with one electrode line. The number of electrode lines connected to the touch electrodes in the second touch electrode set can be reduced. The total number of electrode lines arranged on the touch screen may be reduced, and the fabrication cost of the touch screen may be reduced.

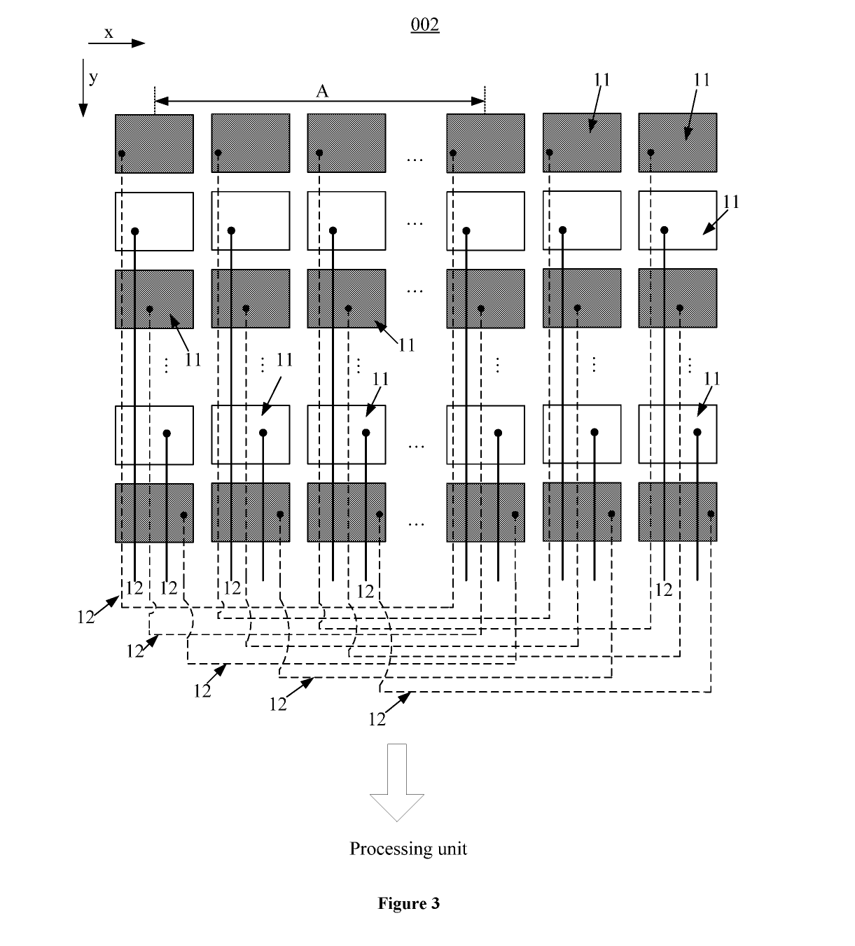

In some embodiments, as shown in FIG. 3, the present disclosure provides the structure of another exemplary touch screen 002. The first touch electrode set and the second touch electrode set may each include a plurality of touch electrode groups arranged along a first direction X. Each touch electrode group may include at least two touch electrodes 11. The touch electrode groups in the first touch electrode set and the touch electrode groups in the second touch electrode set may be arranged in an alternating manner along a second direction Y. For example, one touch electrode group in the first touch electrode set may be arranged between two touch electrode groups in the second touch electrode set along the second direction Y, and vice versa. The first direction X may be perpendicular to the second direction Y. For example, the first direction X may be the gate line scanning direction and the second direction Y may be the data line scanning direction. The gate line scanning direction may refer to the scanning direction along the gate lines of the touch screen 002, and the data line scanning direction may refer to the scanning direction along the data lines of the touch screen 002.

For example, a distance A between any two of the at least two touch electrodes sharing one common electrode line in the second touch electrode set may be greater than a distance, e.g., a predetermined distance. Specifically, if the distance between the two touch electrodes sharing a same common electrode line, is less than or equal to the distance, when the user touches one of the two touch electrodes with a finger, the touch electrodes surrounding the other one of the two touch electrodes may also be touched by the finger. As a result, the signals generated by the touch electrodes surrounding the other one of the two touch electrodes may be greater than a ghost point threshold value, and the processing circuitry may determine the other one of the two touch electrodes, not touched by the finger, has effective contact with the finger, causing the processing circuitry to make an erroneous decision. If the distance, between the two touch electrodes sharing a same common electrode line, is greater than the distance, when the user touches one of the two touch electrodes with a finger, the touch electrodes surrounding the other one of the two touch electrodes may not be touched by the finger. The signals generated by the touch electrodes surrounding the other one of the two touch electrodes being greater than the ghost point threshold value can be avoided. Erroneous decision by the processing circuitry may be avoided.

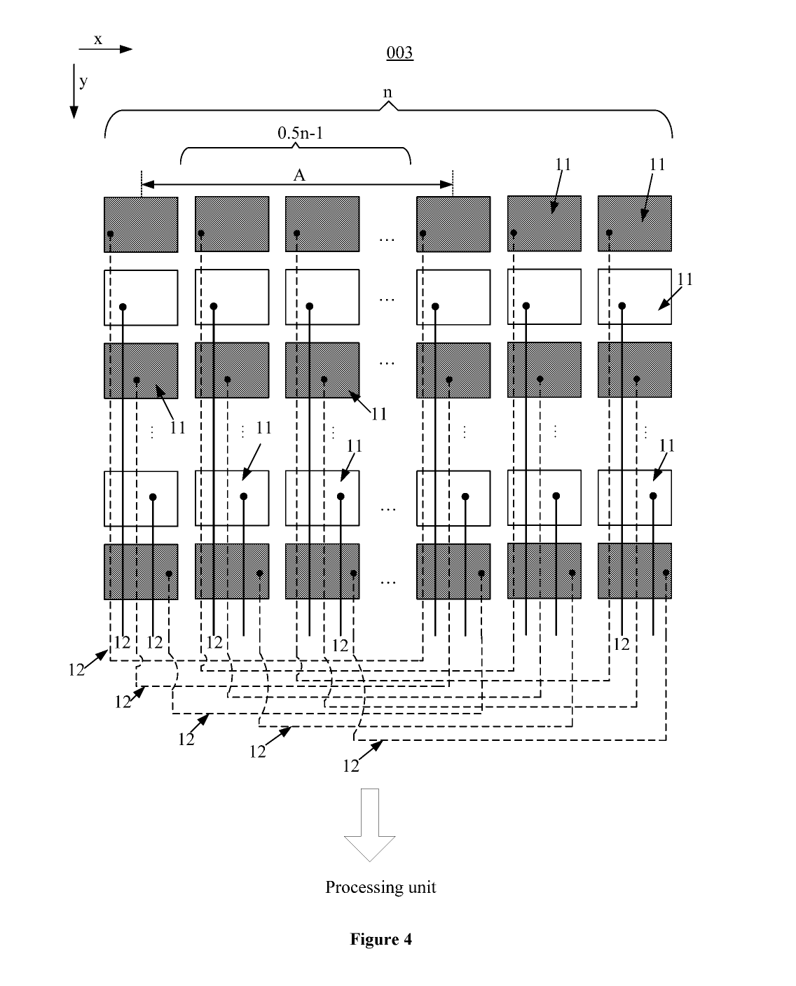

Further, FIG. 4 illustrates the structure of another exemplary touch screen 003. As shown in FIG. 4, the number of touch electrodes, between any two of the at least two touch electrodes sharing a same common electrode line in the second touch electrode set, may be greater than or equal to (0.5n−1), where n may be the number of touch electrodes in the touch electrode group and (0.5n−1) may be an integer according to the value of n. The distance A between any two of the at least two touch electrodes sharing the same common electrode line in the second touch electrode set may be greater than the a value, e.g., a predetermined value. For example, assuming, in FIG. 4, the number of rows n of the touch electrodes on the touch screen 003 may be 28, and the number of columns of the touch electrodes on the touch screen 003 may be 16. Each touch electrode set may include a plurality of touch electrode groups arranged along the first direction X. Each touch electrode group may include 16 touch electrodes. The touch electrode groups in the first touch electrode set and the touch electrode groups in the second touch electrode set may be arranged in an alternating manner along the second direction Y. For example, one touch electrode group in the first touch electrode set may be arranged between two touch electrode groups in the second touch electrode set, and vice versa. The first direction X may be perpendicular to the second direction Y. For example, the first direction X may be the gate line scanning direction and the second direction Y may be the data line scanning direction. The number of touch electrodes, between any two of the at least two touch electrodes sharing a same common electrode line in the second touch electrode set, may be equal to 7. The distance A between any two of the at least two touch electrodes sharing the same common electrode line in the second touch electrode set may be greater than the value.

Thus, in the touch screen provided by the present disclosure, each touch electrode in the first touch electrode set may correspond to one electrode line, and at least two touch electrodes in the second touch electrode set may share one common electrode line. Also, each touch electrode in the second touch electrode set may be neighbored with at least one touch electrode in the first touch electrode set. It may not be necessary to connect each touch electrode to an electrode line. The number of electrode lines used to connect the touch electrodes in the second touch electrode set with the processing circuitry may be reduced. The number of electrode lines in the touch screen may be reduced. The fabrication cost of the touch screen may be reduced.

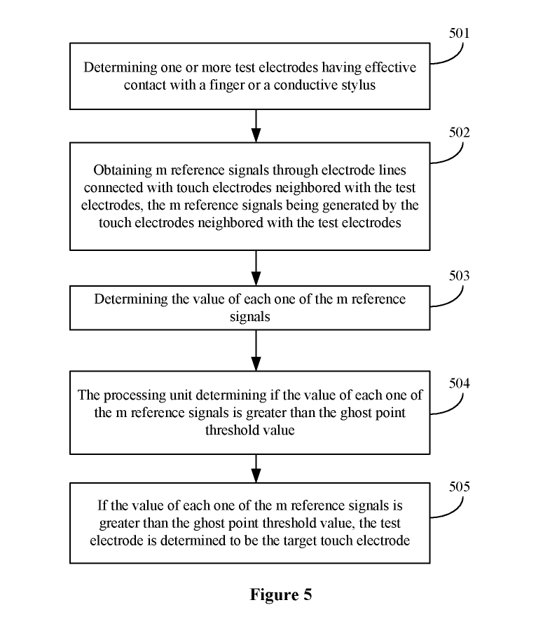

As shown in FIG. 5, the present disclosure further provides a method for controlling a touch screen. The method may be used to control the touch screens exemplarily shown in FIGS. 2, 3, and 4. The method may include steps 501 to steps 505.

In step 501, one or more test electrodes having effective contact with a finger or a conductive stylus may be determined.

In step 502, a number of m reference signals may be obtained through electrode lines connected to touch electrodes neighbored with the test electrodes, where the number of m reference signals may be the signals generated by the touch electrodes neighbored with the test electrodes and, m may be an integer greater than or equal to 1.

In step 503, the value of each one of the m reference signals may be determined.

In step 504, the processing circuitry may determine if each one of the m reference signals is greater than the ghost point threshold value by comparing the value of each one of them reference signals to a ghost point threshold value, where the ghost point threshold value may be used to select the threshold value of the target touch electrode.

In step 505, if the value of each one of the m reference signals is greater than the ghost point threshold value, the test electrode may be the target touch electrode.

Thus, according to the method for controlling the touch screen provided by the present disclosure, after the test electrode has been determined to have effective contact with the finger or the conductive stylus, signals generated by touch electrodes neighbored with the test electrode may be compared to the ghost point threshold value to determine if the test electrode is the target touch electrode. The processing circuitry may thus control the touch screen to display corresponding information such as images. The number of electrode lines used on the touch screen may be reduced and the fabrication cost of the touch screen may be reduced. Meanwhile, the control of the touch screen may be realized.

Optionally, after step 504, the method for controlling the touch screen may further include another step. That is, if the at least one of the m reference signals is less than or equal to the ghost point threshold value, the test electrode may be determined not to be the target touch electrode.

For example, step 501 may include the following process. At the beginning of the process, the signal generated by the first electrode may be obtained through an electrode line connected to the first electrode, where the first electrode may be any one of a plurality of touch electrodes. Further, the value of the signal generated by the first electrode may be determined. The processing circuitry may compare the value of the signal generated by the first electrode to a touch-sensing threshold value, where the touch-sensing threshold value is greater than the ghost point threshold value. Further, if the value of the signal generated by the first electrode is greater than the touch-sensing threshold value, the first electrode may be determined to be the test electrode. The touch-sensing threshold value may be a pre-set value and may be used as a threshold value for selecting or filtering the test electrode among the first electrodes. The ghost point threshold value may be a pre-set value and may be used as a threshold value for selecting or filtering the target touch electrode among the test electrodes. The touch-sensing threshold value and the ghost point threshold value may be determined or adjusted according to different touch screens or product and should not be limited to a fixed value.

Optionally, after step 505, the method for controlling the touch screen may further include obtaining the location information of the target touch electrode and controlling the touch screen to display images based on the location information of the target touch electrode.

Thus, in the disclosed method for controlling the touch screen, after the processing circuitry determines the test electrode has effective contact with the finger or conductive stylus, the processing circuitry may determine if the test electrode is the target touch electrode by comparing the signals generated by the touch electrodes neighbored with the test electrode with the ghost point threshold value for controlling the touch screen. The number of electrode lines on the touch screen may be reduced. The fabrication cost of the touch screen may be reduced. Meanwhile, the control of the touch screen may be realized.

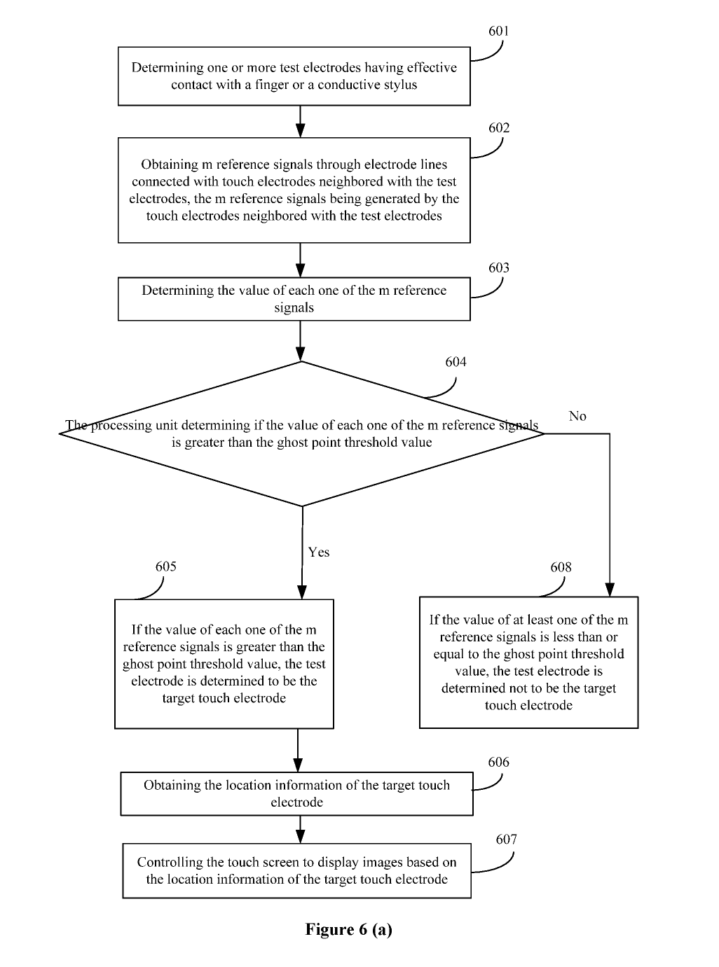

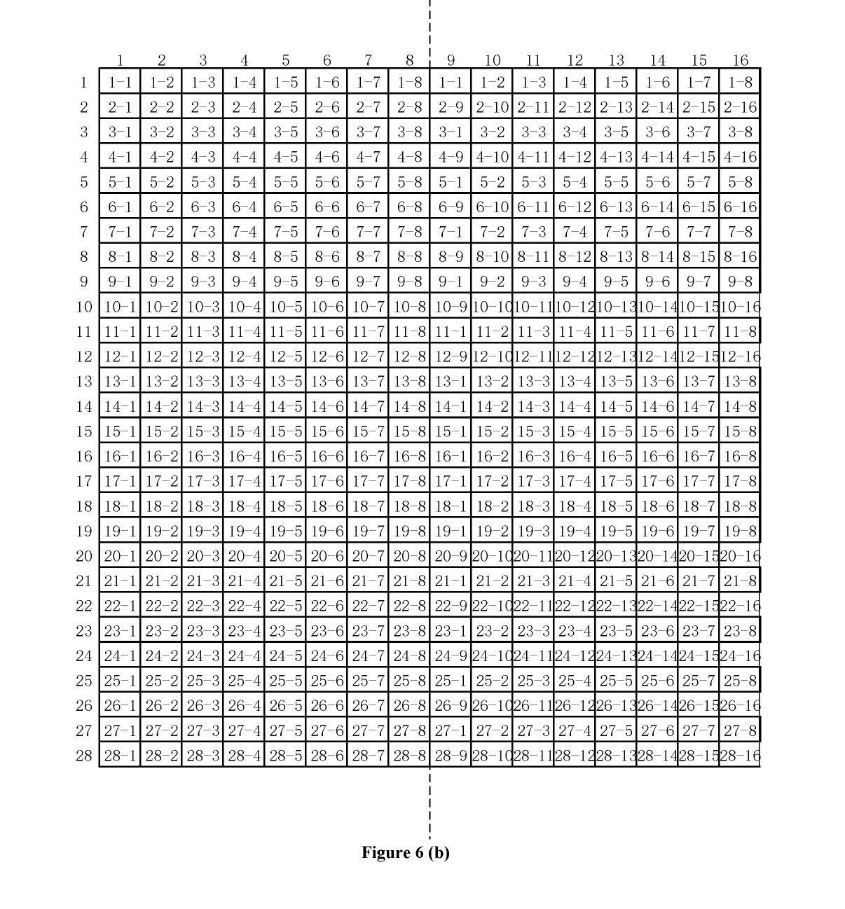

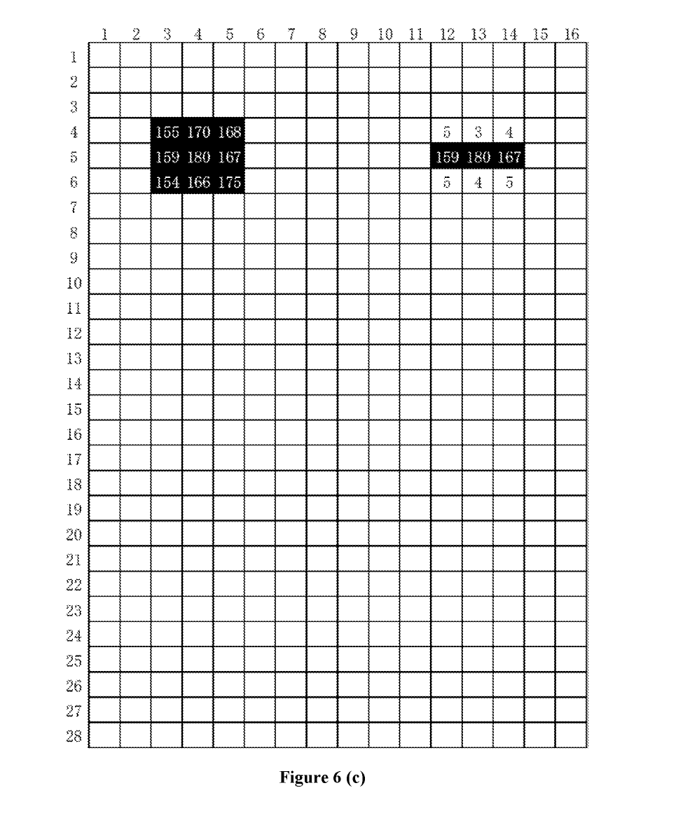

The present disclosure further provides another method for controlling a touch screen. As shown in FIG. 6 (a), the disclosed method may be used to control the touch screen illustrated in FIGS. 2, 3, and 4. The disclosed method may include steps 601 to 607.

In step 601, a test electrode having effective contact with a finger or a conductive stylus may be determined among a plurality of touch electrodes.

Specifically, signal generated by a first electrode may be obtained through the electrode line connected to the first electrode, where the first electrode may be any one of the plurality of touch electrodes. The value of the signal generated by the first electrode may be determined. Further, the value of the signal generated by the first electrode may be compared with the touch-sensing threshold value to determine if the value of the signal generated by the first electrode is greater than the touch-sensing threshold value. If the value of the signal generated by the first electrode is greater than the touch-sensing threshold value, the first electrode may be the test electrode. If the signal generated by the first electrode is less than or equal to the touch-sensing threshold value, the first electrode may not be the test electrode.

For example, the signal generated by the first electrode may be the capacitance on the first electrode. The value of the signal may be the change of capacitance on the first electrode before and after the user's finger touches the first electrode. The signal generated by the first electrode, after the finger has touched the first electrode on the touch screen, may be different from the signal generated by the first electrode before the finger touches the first electrode.

In some embodiments, after the processing circuitry obtains the signal generated by the first electrode and determines the value of the signal, the processing circuitry may compare the value of the signal to the touch-sensing threshold value. If the value of the signal generated by the first electrode is greater than the touch-sensing threshold value, the first electrode may be the test electrode. If the signal generated by the first electrode is less than or equal to the touch-sensing threshold value, the first electrode may not be the test electrode. On one aspect, if the first electrode and another touch electrode share a same common electrode line, after the user's finger touches the first electrode on the touch screen, the signal generated by the first electrode may be greater than the touch-sensing threshold value. The signal generated by the other touch electrode, sharing the same common electrode line with the first electrode, may also be greater than the touch-sensing threshold value. When the finger does not touch the first electrode nor the other touch electrode sharing the same electrode line with the first electrode, the signal generated by the first electrode may be less than or equal to the touch-sensing threshold value. The signal generated by the other touch electrode, sharing the same electrode with the first electrode, may also be less than or equal to the touch-sensing threshold value. On another aspect, if the first electrode does not share a common electrode line with any other touch electrodes, when the finger touches the first electrode, the signal generated by the first electrode may be greater than the touch-sensing threshold value. When the finger does not touch the first electrode, the signal generated by the first electrode may be less than or equal to the touch-sensing threshold value.

Referring back to FIG. 4, in one example, the number of rows of touch electrodes on the touch screen may be 16 and the number of columns of touch electrodes on the touch screen may be 28. Each touch electrode set may include a plurality of touch electrode groups arranged along the first direction X. Each touch electrode group may include 16 touch electrodes. The touch electrode groups in the first touch electrode set and the touch electrode groups in the second touch electrode set may be arranged according to an alternating manner along the second direction Y. For example, one touch electrode group in the first touch electrode set may be arranged between two touch electrode groups in the second touch electrode set along the second direction Y, and vice versa. The second direction Y may be perpendicular to the first direction X. For example, the first direction X may be the gate line scanning direction and the second direction Y may be the data line scanning direction. The distance A between any two of the at least two touch electrodes sharing one electrode line in the second touch electrode set may be greater than a distance, e.g., a predetermined distance. The number of touch electrodes arranged between the any two of the at least two touch electrodes sharing one electrode line in the second touch electrode set may be equal to 7. FIG. 6 (b) illustrates the correspondence relationship between touch electrodes and electrode lines illustrated in FIG. 4. As shown in FIG. 6 (b), the coordinate of a touch electrode along the second direction Y may be m, and the coordinate of the touch electrode along the first direction X may be n. The coordinates of the touch electrode may be (n, m). For example, as shown in FIG. 6 (b), the touch electrode with coordinates of (1, 1) and the touch electrode with coordinates of (1, 9) may share or correspond to electrode line 1-1; the touch electrode with coordinates of (3, 5) and the touch electrode with coordinates of (3, 13) may share or correspond to electrode line 3-5.

The table illustrated in FIG. 6 (b) may be viewed in two parts, separated by a dashed line. On the left hand side of the table, from column 1 to column 8, each touch electrode in the second touch electrode set may share the common electrode line with one touch electrode on the right hand side of the table, from column 9 to column 16. For example, the touch electrode with coordinates of (1, 6) may share the common electrode line with the touch electrode with coordinates of (1, 14); and the touch electrode with coordinates of (12, 6) may share the common electrode line with the touch electrode with coordinates of (12, 14), and so on. Each touch electrode in the first touch electrode set may not share the common electrode line with any other touch electrodes.

For example, the touch electrodes in row 2, 4, 6, and so on, may not share the common electrode line with any other touch electrodes. The touch electrodes in the first touch electrode set and the touch electrodes in the second touch electrode set may be arranged in an alternating manner along the column direction. The column direction may only be used for illustrative purposes and may correspond to the second direction Y. The row direction may only be used for illustrative purposes and may correspond to the first direction X.

In one embodiment, the number of rows of touch electrodes may be 28, and the number of columns of touch electrodes may be 16. The odd rows, e.g., row 1, 3, 5, and so on, may include touch electrodes of the second touch electrode set. In a same row, the touch electrodes from column 1 to column 16 may be in the same touch electrode group. For example, in row 1, the touch electrodes from column 1 to column 16 may be in a same touch electrode group. Each touch electrode in the second touch electrode set, may share the common electrode line with touch electrode in the second touch electrode set in the same touch electrode group. The one other touch electrode may have a higher column number.

As shown in FIG. 6 (b), the touch electrode with coordinates of (5, 3) may share the common electrode line with the touch electrode with coordinates of (5, 11), where 7 (0.5×16−1=7) touch electrode may be arranged between the touch electrodes with coordinates of (5, 3) and (5, 7) and 16 is the number of touch electrodes in the corresponding touch electrode group. The two touch electrodes sharing the same electrode line may be separated by 7 touch electrodes.

As shown in FIG. 6 (c), when the finger touches touch electrodes with coordinates of (4, 3), (4, 4), (4, 5), (5, 3), (5, 4), (5, 5), (6, 3), (6, 4), and (6, 5), the processing circuitry may obtain signals generated by the touch electrodes with coordinates of (4, 3), (4, 4), (4, 5), (5, 3), (5, 4), (5, 5), (6, 3), (6, 4), and (6, 5) through the electrode lines connected with the touch electrodes with coordinates of (4, 3), (4, 4), (4, 5), (5, 3), (5, 4), (5, 5), (6, 3), (6, 4), and (6, 5). The values of the signals may be 155, 170, 168, 159, 180, 167, 154, 166, and 175. The touch-sensing threshold value may be 179. Thus, the touch electrode with coordinates of (5, 4) may be the test electrode having effective contact with the finger.

The touch electrode with coordinates of (5, 12) and the touch electrode with coordinates of (5, 3) share one common electrode line; the touch electrode with coordinates of (5, 13) and the touch electrode with coordinates of (5, 4) share one common electrode line; the touch electrode with coordinates of (5, 14) and the touch electrode with coordinates of (5, 5) share one common electrode line; and the signals generated by the touch electrodes sharing the same electrode line may have the same value. Thus, through the electrode lines connected to the touch electrodes with coordinates of (5, 12), (5, 13), and (5, 14), the values of the signals generated by the touch electrodes with coordinates of (5, 12), (5, 13), and (5, 14), i.e., 159, 180, and 167, may be obtained by the processing circuitry. The touch-sensing threshold value may be 179. The processing circuitry may determine the touch electrode with coordinates of (5, 13) to be the test electrode having effective contact with the finger.

In step 602 of FIG. 6, a number of m reference signals may be obtained through the electrode lines connected with the touch electrodes neighbored with the test electrode, where the m reference signals may be generated by the touch electrodes neighbored with the test electrode and m is an integer greater than or equal to 1.

In some embodiments, after the test electrode has been determined, the processor may obtain m reference signals through the electrode lines connected with the touch electrodes neighbored with the test electrode, where the number of m reference signals may be generated by the touch electrodes neighbored with the test electrode. For example, as shown in FIG. 6 (c), after the touch electrode with coordinates of (5, 4) has been determined to be the test electrode, the processing circuitry may obtain signals generated by 8 touch electrodes neighbored with the test electrode with coordinates of (5, 4) and may determine the signals to be the reference signals generated by the 8 touch electrodes neighbored with the test electrode with coordinates of (5, 4); after the processing circuitry determines the touch electrode with coordinates of (5, 13) to be the test electrode, the processing circuitry may obtain signals generated by 8 touch electrodes neighbored with the test electrode with coordinates of (5, 13) and determine the signals to be the reference signals generated by the 8 touch electrodes neighbored with the test electrode with coordinates of (5, 13). For example, the touch electrodes neighbored with the test electrode with coordinates of (5, 4) may have the coordinates of (4, 3), (4, 4), (4, 5), (5, 3), (5, 5), (6, 3), (6, 4), and (6, 5); and the touch electrodes neighbored with the test electrode with coordinates of (5, 13) may have the coordinates of (4, 12), (4, 13), (4, 14), (5, 12), (5, 14), (6, 12), (6, 13), and (6, 14).

It should be noted that, for test electrodes being close to or on the edge of the touch electrode array, the number of reference signals that can be obtained by the processor may be less. For example, in an array of touch electrodes with 28 rows and 16 columns of touch electrodes, if a test electrode is determined to be in column 1 or column 15, the number of touch electrodes neighbored with the test electrode may be less than 8. Same process may be used to determine if the test electrode is the target touch electrode and is not repeated herein.

In step 603, the value of each one of the m reference signals may be determined.

After the number of m reference signals are obtained, the value of each one of the m reference signals may be determined based on the m reference signals. The process and/or method to determine the value of each one of the m reference signals based on the m reference signals may refer to a suitable process for determine the value of the signal generated by a touch electrode based on the signal and is not repeated herein.

In step 604, the processing circuitry may determine if the value of each one of the m reference signals is greater than the ghost point threshold value. If the value of each one of the m reference signals is greater than the ghost point threshold value, the process may proceed to step 605. If at least one reference signal, among the m reference signals, has a value less than or equal to the ghost point threshold value, the process may proceed to step 608.

In some embodiments, after the value of each reference signal has been determined, the processing circuitry may compare the value of each reference signal to the ghost point threshold value to obtain the difference between the reference signal and the ghost point threshold value. If the value of one reference signal subtracted by the ghost point threshold value yields a positive value, the processing circuitry may determine the reference signal is greater than the ghost point threshold value. If the value of one reference signal subtracted by the ghost point threshold value yields a negative value or zero, the processing circuitry may determine the reference signal is less than or equal to the ghost point threshold value. It should be noted that, the ghost point threshold value may be less than the touch-sensing threshold value.

For example, as shown in FIG. 6 (c), among the touch electrodes neighbored with the test electrode with coordinates of (5, 4), the value of the signal generated by the touch electrode with coordinates of (4, 3) may be 155; the value of the signal generated by the touch electrode with coordinates of (4, 4) may be 170; the value of the signal generated by the touch electrode with coordinates of (4, 5) may be 168; the value of the signal generated by the touch electrode with coordinates of (5, 3) may be 159; the value of the signal generated by the touch electrode with coordinates of (5, 5) may be 167; the value of the signal generated by the touch electrode with coordinates of (6, 3) may be 154; the value of the signal generated by the touch electrode with coordinates of (6, 4) may be 166; and the value of the signal generated by the touch electrode with coordinates of (6, 5) may be 175.

Among the touch electrodes neighbored with the test electrode with coordinates of (5, 13), the value of the signal generated by the touch electrode with coordinates of (4, 12) may be 5; the value of the signal generated by the touch electrode with coordinates of (4, 13) may be 3; the value of the signal generated by the touch electrode with coordinates of (4, 14) may be 4; the value of the signal generated by the touch electrode with coordinates of (5, 12) may be 159; the value of the signal generated by the touch electrode with coordinates of (5, 14) may be 167; the value of the signal generated by the touch electrode with coordinates of (6, 12) may be 5; the value of the signal generated by the touch electrode with coordinates of (6, 13) may be 4; and the value of the signal generated by the touch electrode with coordinates of (6, 14) may be 5.

It should be noted that, because the two touch electrodes sharing the same common electrode line may generated signals with the same value, the touch electrode with coordinates of (5, 12) and the touch electrode with coordinates of (5, 13) may share the same common electrode line, and the touch electrode with coordinates of (5, 14) and the touch electrode with coordinates of (5, 5) may share the same common electrode line, the signals generated by the touch electrode with coordinates of (5, 12) and the touch electrode with coordinates of (5, 3) may have the same value of 159, and the signals generated by the touch electrode with coordinates of (5, 14) and the touch electrode with coordinates of (5, 5) may have the same value of 167.

For example, the ghost point threshold value may be set to be 50. By comparing the ghost point threshold value with the value of each reference signal, it may be determined that the values of the 8 reference signals corresponding to the test electrode with coordinates of (5, 4) may be greater than the ghost point threshold value. It may also be determined that among the 8 reference signals corresponding to the test electrode with coordinates of (5, 13), the values of two of the reference signals may be greater than the ghost point threshold value, and the values of six of the reference signals may be less than the ghost point threshold value.

In step 605, if the values of the m reference signals are all greater than the ghost point threshold value, the test electrode may be determined to be the target touch electrode.

If the values of the m touch electrodes neighbored with the test electrode are all greater than the ghost point threshold value, i.e., the values of the m reference signals are all greater than the ghost point threshold value, the processing circuitry may determine the test electrode as the target touch electrode. That is, the ghost point threshold value may be a threshold value used for selecting or filtering the target touch electrode among the test electrodes. As shown in FIG. 6 (c), because the values of the 8 reference signals corresponding to the test electrode with coordinates of (5, 4) are all greater than the ghost point threshold value, the processing circuitry may determine the test electrode with coordinates of (5, 4) may be the target touch electrode.

In step 606, the location information of the target touch electrode may be obtained.

After the test electrode with coordinates of (5, 4) has been determined to be the target touch electrode, the processing circuitry may obtain the location information of the target touch electrode. For example, the location information of the target touch electrode may be indicated by coordinates of the target touch electrode on the touch screen. It should be noted that, the location information of the target touch electrode may also be indicated by other suitable information and/or signals and should not be limited by the embodiments of the present disclosure.

In step 607, the touch screen may be controlled to display images based on the location information of the touch electrode.

After the location information of the target touch electrode is obtained, the processing circuitry may control the touch screen to display images based on the location information of the touch electrode.

In step 608, if the value of at least one reference signal, among the m reference signals, is less than or equal to the ghost point threshold value, the processing circuitry may determine the test electrode is not the target touch electrode.

If the value of at least one reference signal, among the m reference signals, is less than or equal to the ghost point threshold value, the processing circuitry may determine the test electrode is not the target touch electrode. As shown in FIG. 6 (c), because among the 8 reference signals corresponding to the test electrode with coordinates of (5, 13), the values of two of the reference signals are greater than the ghost point threshold value, and the values of six of the reference signals are less than the ghost point threshold value, the processing circuitry may determine that the test electrode with coordinates of (5, 13) is not the target touch electrode.

After it has been determined that the test electrode has effective contact with the finger or the conductive stylus, the processing circuitry may compare the signals generated by the touch electrodes neighbored with the test electrode to the ghost point threshold value to determine if the test electrode is the target touch electrode. Erroneous decision of the target touch electrode, caused by the two touch electrodes sharing the same common electrode line, can be avoided or reduced.

If one touch electrode has effective contact with the finger or the conductive stylus, the touch signal generated by the touch electrode may be greater than the touch-sensing threshold value. Because when a finger is touching the touch electrode, the contact area on the touch screen, contacted by the finger, may be larger than the area of the touch electrode, the values of the touch signals generated by the touch electrodes neighbored with the touch electrode being touched may be greater than the ghost point threshold value. The value of the other touch electrode, sharing the same common electrode line with the touch electrode being touched, may also be greater than the touch-sensing threshold value. Because the finger or conductive stylus does not touch the other touch electrode, the values of the signals generated by the touch electrodes neighbored with the other touch electrode may be less than the ghost point threshold value. By determining if the value of the touch signal of one touch electrode is greater than the touch-sensing threshold value and if the values of the touch signals of the touch electrodes neighbored with the one touch electrode are greater than the ghost point threshold value, the processing circuitry may determine if the one touch electrode has effective contact with the finger or the conductive stylus.

Thus, because in the disclosed method for controlling the touch screen, after the processing circuitry determines the test electrode has effective contact with the finger or the conductive stylus, the processing circuitry may compare the values of the signals generated by the touch electrodes neighbored with the test electrode to determine if the test electrode is the target touch electrode. Thus, the processing circuitry may control the touch screen. The number of electrode lines used on the touch screen may be reduced and the fabrication cost of the touch screen may be reduced simultaneously. Also, the touch screen may be controlled.

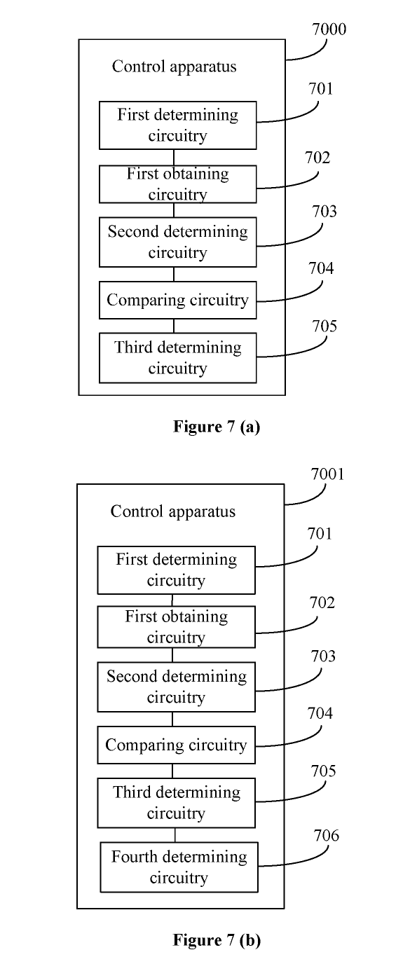

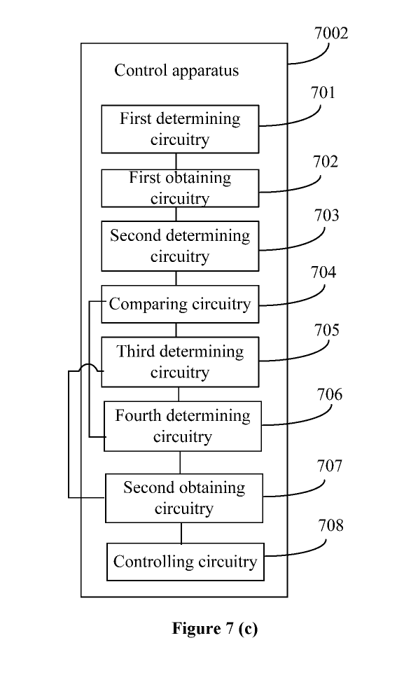

Embodiments of the present disclosure further provide a control apparatus for the touch screen. FIG. 7 (a) illustrates the control apparatus 7000 used for controlling the touch screens illustrated in FIGS. 2, 3, and 4. The control apparatus 7000 may include a first determining circuitry 701, a first obtaining circuitry 702, a second determining circuitry 703, a comparing circuitry 704, and a third determining circuitry 705.

The first determining circuitry 701 may be configured to determine one or more test electrodes having effective contact with the finger or conductive stylus. The first obtaining circuitry 702 may be configured to obtain a number of m reference signals generated by the touch electrodes neighbored with the test electrodes, where the number m is an integer greater than or equal to 1. The first obtaining circuitry 702 may obtain the m reference signals through the electrode lines connected with the touch electrodes neighbored with the one or more test electrodes. The second determining circuitry 703 may be used to determine the value of each one of the m reference signals. The comparing circuitry 704 may be configured to compare the value of each one of the m reference signals to the ghost point threshold value to determine if the value of each one of the m reference signals is greater than the ghost point threshold value. The ghost point threshold value may be used for selecting or filtering target touch electrode. The third determining circuitry 705 may be configured to determine the detecting target to be the target touch electrode when the value of each one of the m reference signals is greater than the ghost point threshold value.

Thus, in the control apparatus provided by the embodiments of the present disclosure, after the first determining circuitry determines the test electrode has effective contact with the finger or the conductive stylus, the comparing circuitry and the third determining circuitry may determine if the test electrode is the target touch electrode based on the comparison of the values of the signals generated by the touch electrodes neighbored with the detecting circuitry with the ghost point threshold value. The touch screen may be controlled and the number of electrode lines on the touch screen may be reduced. The fabrication cost of the touch screen may be reduced and the touch screen may be controlled.

Embodiments of the present disclosure further provide another control apparatus of the touch screen. FIG. 7 (b) illustrates the control apparatus 7001 used for controlling the touch screen illustrated in FIGS. 2, 3, and 4. The control apparatus 7001 may include a first determining circuitry 701, a first obtaining circuitry 702, a second determining circuitry 703, a comparing circuitry 704, a third determining circuitry 705, and a fourth determining circuitry 706.

The first determining circuitry 701 may be configured to determine one or more test electrodes having effective contact with the finger or conductive stylus. The first obtaining circuitry 702 may be configured to obtain a number of m reference signals generated by the touch electrodes neighbored with the test electrodes, where the number m is an integer greater than or equal to 1. The first obtaining circuitry 702 may obtain the m reference signals through the electrode lines connected with the touch electrodes neighbored with the one or more test electrodes. The second determining circuitry 703 may be used to determine the value of each one of the m reference signals. The comparing circuitry 704 may be configured to compare the value of each one of the m reference signals to the ghost point threshold value to determine if the value of each one of the m reference signals is greater than the ghost point threshold value. The ghost point threshold value may be used for selecting or filtering target touch electrode. The third determining circuitry 705 may be configured to determine the detecting target to be the target touch electrode when the value of each one of the m reference signals is greater than the ghost point threshold value. The fourth determining circuitry 706 may be configured to determine that, when the value of at least one of the m reference signals is less than or equal to the ghost point threshold value, the test electrode is not the target touch electrode.

Thus, in the control apparatus provided by the embodiments of the present disclosure, after the first determining circuitry determines the test electrode has effective contact with the finger or the conductive stylus, the comparing circuitry and the third determining circuitry may determine if the test electrode is the target touch electrode based on the comparison of the values of the signals generated by the touch electrodes neighbored with the detecting circuitry with the ghost point threshold value. The touch screen may be controlled and the number of electrode lines on the touch screen may be reduced. The fabrication cost of the touch screen may be reduced and the touch screen may be controlled.

For example, the first determining circuitry 701 may be used to obtain the signal generated by the first electrode through the electrode line connected with the first electrode, where the first electrode may be any touch electrode in a plurality of touch electrodes. The first determining circuitry 701 may determine the value of the signal generated by the first electrode and compare if the value of the signal generated by the first electrode is greater than the touch-sensing threshold value, where the touch-sensing threshold value is greater than the ghost point threshold value. The first determining circuitry 701 may also determine the first electrode to be the test electrode if the value of the signal generated by the first electrode is greater than the touch-sensing threshold value.

Embodiments of the present disclosure further provide another control apparatus of the touch screen. FIG. 7 (c) illustrates the control apparatus 7002 used for controlling the touch screen illustrated in FIGS. 2, 3, and 4. The control apparatus 7002 may include a first determining circuitry 701, a first obtaining circuitry 702, a second determining circuitry 703, a comparing circuitry 704, a third determining circuitry 705, a fourth determining circuitry 706, a second obtaining circuitry 707, and a controlling circuitry 708.

The first determining circuitry 701 may be configured to determine one or more test electrodes having effective contact with the finger or conductive stylus. The first obtaining circuitry 702 may be configured to obtain a number of m reference signals generated by the touch electrodes neighbored with the test electrodes, where the number m is an integer greater than or equal to 1. The first obtaining circuitry 702 may obtain the m reference signals through the electrode lines connected with the touch electrodes neighbored with the one or more test electrodes. The second determining circuitry 703 may be used to determine the value of each one of the m reference signals. The comparing circuitry 704 may be configured to compare the value of each one of the m reference signals to the ghost point threshold value to determine if the value of each one of the m reference signals is greater than the ghost point threshold value. The ghost point threshold value may be used for selecting or filtering target touch electrode. The third determining circuitry 705 may be configured to determine the detecting target to be the target touch electrode when the value of each one of the m reference signals is greater than the ghost point threshold value. The fourth determining circuitry 706 may be configured to determine that, when the value of at least one of the m reference signals is less than or equal to the ghost point threshold value, the test electrode is not the target touch electrode. The second obtaining circuitry 707 may be used to obtain the location information of the target touch electrode. The controlling circuitry 708 may be configured to control the touch screen to display images based on the location information of the target touch electrode.

Thus, in the control apparatus provided by the embodiments of the present disclosure, after the first determining circuitry determines the test electrode has effective contact with the finger or the conductive stylus, the comparing circuitry and the third determining circuitry may determine if the test electrode is the target touch electrode based on the comparison of the values of the signals generated by the touch electrodes neighbored with the detecting circuitry with the ghost point threshold value. The touch screen may be controlled and the number of electrode lines on the touch screen may be reduced. The fabrication cost of the touch screen may be reduced and the touch screen may be controlled.

The first determining circuitry, the first obtaining circuitry, the second determining circuitry, the comparing circuitry, the third determining circuitry, the fourth determining circuitry, the second obtaining circuitry, and the controlling circuitry may each include suitable circuits and components for corresponding functions. The above-mentioned circuitries may be separated from the processing circuitry or may be at least partially integrated with the processing circuitry for executing corresponding functions.

Another aspect of the present disclosure provides a touch display apparatus. The display apparatus may incorporate one or more of the above-mentioned touch screen and the processing circuitry. The touch screen may be the touch screen illustrated in any one of FIGS. 2, 3, and 4. The processing circuitry may be the control apparatus illustrated in any one of FIGS. 7 (a), 7 (b), and 7 (c). Specifically, the touch display apparatus according to the embodiments of the present disclosure can be used in any product with display functions such as a liquid crystal display panel, an organic light-emitting diode display panel, a television, a tablet, a monitor, an electronic paper, a digital photo frame, a mobile phone and a tablet computer.

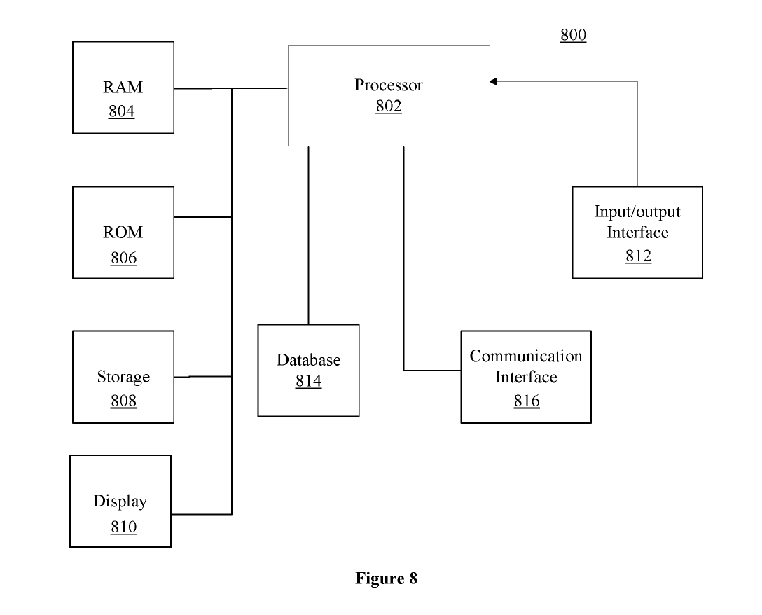

FIG. 8 illustrates an exemplary processing circuitry 800 used in some embodiments of the present disclosure. The processing circuitry 800 or processing system may receive, process, and execute commands from the touch screen. The processing circuitry 800 may include any appropriately configured computer system. As shown in FIG. 12, the processing circuitry 800 may include a processor 802, a random access memory (RAM) 804, a read-only memory (ROM) 806, a storage 808, a display 810, an input/output interface 812, a database 814; and a communication interface 816. Other components may be added and certain components may be omitted without limiting the scope of the present disclosure.

Processor 802 may include any appropriate type of general purpose microprocessor, digital signal processing circuitry or microcontroller, and application specific integrated circuit (ASIC). Processor 802 may execute sequences of computer program instructions to perform various functions associated with processing circuitry 800. Computer program instructions may be loaded into RAM 804 for execution by processor 802 from ROM 806, or from storage 808. Storage 808 may include any appropriate type of mass storage provided to store any type of information that processor 802 may need to perform the processes. For example, storage 808 may include one or more hard disk devices, optical disk devices, flash disks, or other storage devices that provide storage space.

Display 810 may provide information to a user or users of the processing circuitry 800. Display 810 may include any appropriate type of computer display device or electronic device display (e.g., CRT or LCD based devices). Input/output interface 812 may be provided for users to input information into the processing circuitry 800 or for the users to receive information from the processing circuitry 800. For example, input/output interface 812 may include any appropriate input device, such as a keyboard, a mouse, an electronic tablet, voice communication devices, or any other optical or wireless input devices. Further, input/output interface 812 may receive from and/or send to other external devices.

Further, database 814 may include any type of commercial or customized database, and may also include analysis tools for analyzing the information in the databases. Database 814 may be used for storing information for semiconductor manufacturing and other related information. Communication interface 816 may provide communication connections, such that the processing circuitry 800 may be accessed remotely and/or communicate with other systems through computer networks or other communication networks via various communication protocols, such as transmission control protocol/internet protocol (TCP/IP), hyper text transfer protocol (HTTP), etc.

In one embodiment, a user may input commands via the input/output interface 812 or touch the touch screen to start a desired program. The processor 802 may receive, process, and execute the commands or signals to control the touch screen to display images. The communication interface can communicate with other devices based on the commands. Suitable data may be stored in ROM 806 and storage 808 to be processed. After the data is processed, result of the self-monitoring can be obtained. The result can be returned to the user via the display 810 or the input/output interface 812.

Thus, according to the display apparatus provided by the present disclosure, each touch electrode in the first touch electrode set of the touch screen may correspond to one electrode line; and at least two touch electrodes in the second touch electrode set of the touch screen may correspond to one electrode line. Each touch electrode in the second touch electrode set may be neighbored with at least one touch electrode in the first touch electrode set. It is not necessary to connect each touch electrode with an electrode line.

After the processing circuitry determines the test electrode has effective contact with a finger or a conductive stylus, the processing circuitry may determine if the test electrode is the target touch electrode by comparing the values of the signals generated by the touch electrodes neighbored with the test electrode with the ghost point threshold value. The number of electrode lines connected with the touch electrodes in the second touch electrode set may be reduced, and the total number of electrode lines used in the touch screen may be reduced simultaneously. The touch screen may also be controlled. The fabrication cost of the touch screen may be reduced.

It should be understood that the above embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1-10. (canceled)

11. A touch screen, comprising:
a plurality of touch electrodes arranged in an array; and
a plurality of electrode lines, each electrode line being connected to at least one touch electrode,
wherein:
the plurality of touch electrodes includes a first touch electrode set and a second touch electrode set;
each touch electrode in the first touch electrode set is connected to a distinct electrode line, each electrode line being connected to a distinct touch electrode; and
at least two touch electrodes in the second touch electrode set are connected to a common electrode line, wherein each of the at least two touch electrodes in the second touch electrode set is neighbored with at least one touch electrode in the first touch electrode set.

12. The touch screen according to claim 11, wherein:
each of the first touch electrode set and the second touch electrode set includes a plurality of touch electrode groups arranged along a first direction, each touch electrode group including at least two touch electrodes; and
the first touch electrode set and the second touch electrode set are arranged in an alternating manner along a second direction, the second direction being perpendicular to the first direction.

13. The touch screen according to claim 12, wherein a distance between any two of the at least two touch electrodes sharing the one electrode line in the second touch electrode set is greater than a distance.

14. The touch screen according to claim 13, wherein a number of touch electrodes between any two of the at least two touch electrodes sharing the one electrode line in the second touch electrode set is greater than or equal to (0.5n−1), (0.5n−1) being a rounded integer according to n, and n being a number of touch electrodes in a corresponding touch electrode group.

15. The touch screen according to claim 11, wherein the processing circuitry is configured to select at least one test electrode and determining a target touch electrode among the at least one test electrodes, wherein the at least one test electrode has effective contact with a finger or a conductive stylus.

16. A touch display apparatus, including one or more of the touch screens according to claim 11.

17. A control apparatus for controlling the touch screen according to claim 11, comprising:
a first determining circuitry, configured to determine a test electrode contacted by a finger or a conductive stylus;
a first obtaining circuitry, configured to obtain a number of m reference signals generated by the touch electrodes neighbored with the test electrode, wherein m is an integer greater than or equal to 1;
a second determining circuitry, configured to determine a value of each one of the m reference signals;
a comparing circuitry, configured to compare the value of each one of the m reference signals to a ghost point threshold value to determine if the value of each one of the m reference signals is greater than the ghost point threshold value; and
a third determining circuitry, configured to determine a target touch electrode when the value of each one of the m reference signals is greater than the ghost point threshold value.

18. The control apparatus according to claim 17, further including a fourth determining circuitry, configured to determine when a value of at least one of the m reference signals is less than or equal to the ghost point threshold value, the test electrode is not the target touch electrode.

19. The control apparatus according to claim 17, wherein the first determining circuitry is configured to:
obtain a signal generated by a first electrode through an electrode line connected with the first electrode, where the first electrode is any touch electrode in the plurality of touch electrodes;
determine a value of the signal generated by the first electrode;
compare if the value of the signal generated by the first electrode is greater than the touch-sensing threshold value, where the touch-sensing threshold value is greater than the ghost point threshold value; and
determine the first electrode to be a test electrode if the value of the signal generated by the first electrode is greater than the touch-sensing threshold value.

20. The control apparatus according to claim 19, further including:
a second obtaining circuitry, configured to obtain location information of the target touch electrode; and
a controlling circuitry, configured to control the touch screen to display images based on the location information of the target touch electrode.
